(19) United States
(12) Patent Application Publication
(10) Pub. No.: US 2016/0122079 A1
(43) Pub. Date: May 5, 2016

(54) Pallet for transportation of flammable gases

(71) Applicant: Leslie Doyle, Merryville, LA (US)

(72) Inventor: Leslie Doyle, Merryville, LA (US)

(21) Appl. No.: 14/928,960

(22) Filed: Oct. 30, 2015

Related U.S. Application Data
(60) Provisional application No. 62/075,330, filed on Nov. 5, 2014.

(51) Int. Cl. B65D 19/44; B60B 33/00; B65D 19/42

(52) U.S. Cl. CPC B65D 19/44; B65D 19/42; B60B 33/0089; B65D 2519/00796; B65D 2519/00786; B65D 2519/00781

(57) ABSTRACT

A pallet for transportation of flammable gases allows tanks containing flammable gas to be securely transported. The pallet is manufactured from steel or aluminum alloy, and provides apertures for a forklift to lift and carry the pallet. A T-shaped vertical post extends upward from the center of the pallet platform, terminating in a ring at the center of the crossbar, so the pallet may hang from the bucket of a crane or endloader and be carried. Ring clamps are provided on the sides of the post, enabling users to secure two tanks of welding gases in a vertical position on the post, with their lower ends resting on the pallet platform. Hooks are provided on the post, so coiled hoses may hang on them. An open-topped toolbox may be provided on the top of the pallet platform, and caster wheels may be provided on the corners of the bottom.

### CROSS-REFERENCE TO RELATED APPLICATIONS

This application claims the benefit of U.S. Provisional Application No. 62/075,330 filed Nov. 5, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to industrial equipment and in particular to a pallet for transportation of flammable gases. At industrial and construction sites, shipyards, and similar locations, heavy tanks of welding gases must be transported and delivered to various work sites. These gases, oxygen and acetylene, present a substantial risk of explosion and fire if they are not handled safely. A device which enables users to safely transport heavy tanks of flammable gases with a forklift or other types of heavy machinery would not only reduce accidents and injuries, but would also provide peace of mind to supervisors, workers, and their families. A pallet for transportation of flammable gases, which enables workers to use a forklift, a crane, or other heavy machinery to safely lift and carry welding tanks, would resolve this problem.

The prior art consists of bulky cages and racks in order to hold the flammable gas tanks. While this works, it is inefficient and unnecessary. Each individual gas tank has its own compartment and frame to support it. This requires excessive material which is not necessary in order to stably hold the gas tanks in place. Additionally, the prior art lacks the ability to be lifted by cranes or endloaders without including a separate support or loop from the main frame. These limitations on the present prior art are easily fixed and improved upon by the present invention.

### SUMMARY OF THE INVENTION

Accordingly, the invention is directed to a pallet for transportation of flammable gases. The pallet is preferably manufactured from steel or aluminum alloy to provide structural strength, and provides apertures for a forklift to lift and carry the pallet. A T-shaped vertical post extends upward from the center of the pallet platform, terminating in a ring at the center of the crossbar, such that the pallet may hang from the bucket of a crane or endloader and be carried. This single T-shaped vertical post provides all the support necessary for the flammable gas tanks. Ring clamps are provided on the sides of the post, which enable users to secure multiple tanks of welding gases in a vertical position on the post, with their lower ends resting on the pallet platform. Hooks are also provided on the post, such that the user may hang coiled hoses on them. Optionally, an open-topped toolbox may be provided on the top surface of the pallet platform, and caster wheels may be provided on the corners of the bottom surface.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate two embodiments of the invention and, together with the description, serve to explain the principles of the invention.

FIG. 1 provides a front view of the first exemplary embodiment, displaying the pallet 10, the pallet platform 11, the apertures 11A, the post 12, the ring 12A, the crossbar 12B, the ring clamps 13, and the hooks 14.

FIG. 2 provides a side view of the first exemplary embodiment, displaying the pallet 10, the pallet platform 11, the apertures 11A, the post 12, the ring 12A, the crossbar 12B, the ring clamps 13, and the hooks 14.

FIG. 3 provides a front perspective view of the first exemplary embodiment, displaying the pallet 10, the pallet platform 11, the apertures 11A, the post 12, the ring 12A, the crossbar 12B, the ring clamps 13, and the hooks 14.

FIG. 4 provides a front view of the second exemplary embodiment, displaying the pallet 10, the apertures 11A, the post 12, the ring 12A, the crossbar 12B, the ring clamps 13, the hooks 14, the toolbox 15, and the caster wheels 16.

FIG. 5 provides a side view of the second exemplary embodiment, displaying the pallet 10, the apertures 11A, the post 12, the ring 12A, the crossbar 12B, the ring clamps 13, the hooks 14, the toolbox 15, and the caster wheels 16.

FIG. 6 provides a front perspective view of the second exemplary embodiment, displaying the pallet 10, the pallet platform 11, the apertures 11A, the post 12, the ring 12A, the crossbar 12B, the ring clamps 13, the hooks 14, and the caster wheels 16.

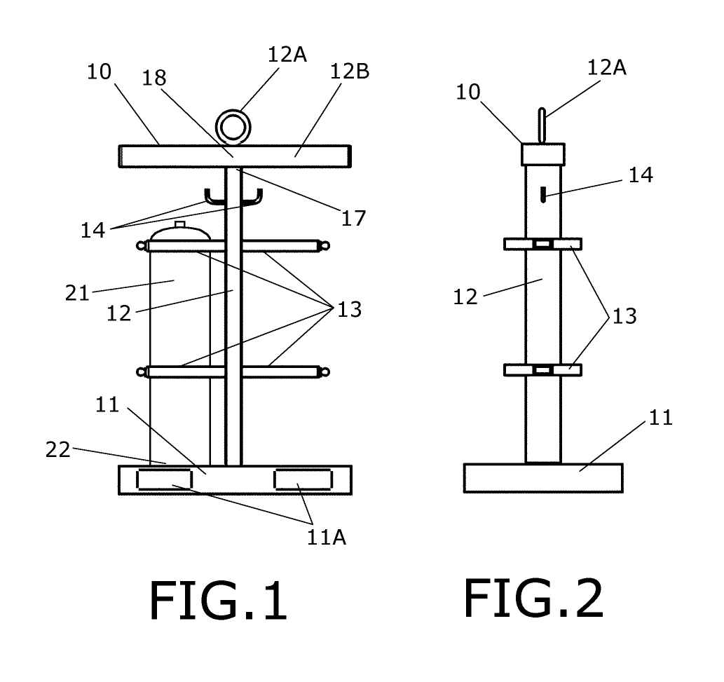

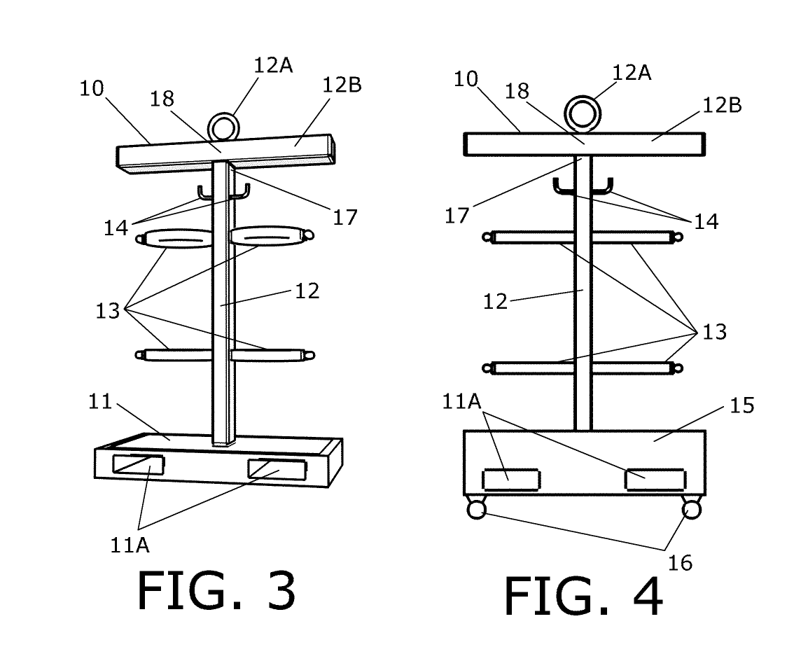

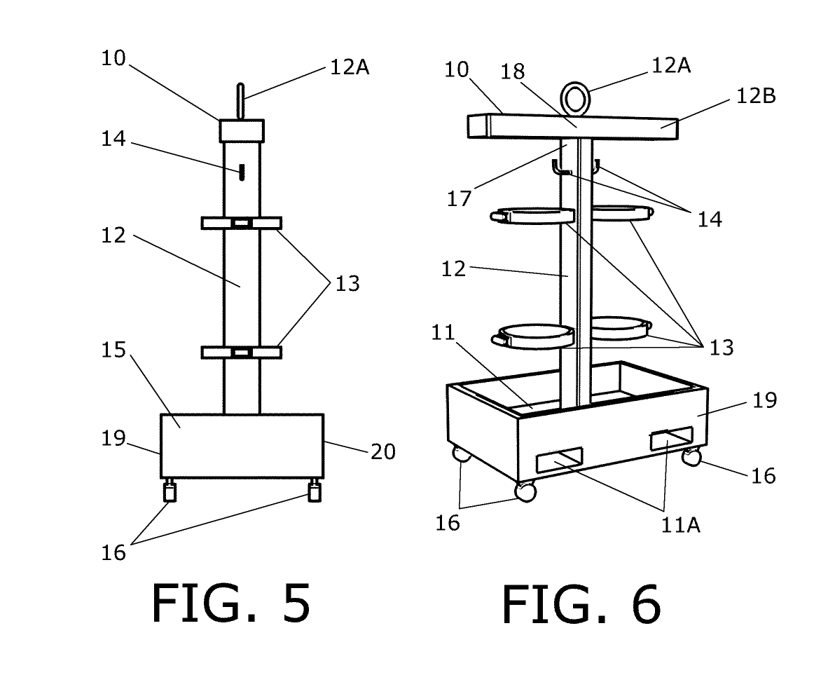

### DETAILED DESCRIPTION OF THE INVENTION

Referring now to the invention in more detail, the invention is directed to a pallet 10 for transportation of flammable gases.

It is to be understood that while the invention is intended for transportation of flammable gases, this is not intended as a limitation. With suitable modifications or with no modifications at all, the invention may be used for transportation of any large, heavy object which presents greater than ordinary risks during transportation, such as fire or explosion.

The first exemplary embodiment is comprised of a pallet 10, which is preferably manufactured from steel or aluminum alloy to provide structural strength, and provides apertures 11A for a forklift to lift and carry the pallet. The apertures 11A extend from the front surface 19 to the rear surface 20 of the pallet platform 11.

A T-shaped vertical post 12 extends upward from the center of the pallet platform 11, terminating in a ring 12A at the center 18 of the crossbar 12B, such that the pallet 10 may hang from the bucket of a crane or endloader and be carried. The crossbar 12B extends outward side to side from the upper end 17 of the vertical post 12. Ring clamps 13 are provided on the sides of the post 12, which enable users to secure two tanks 21 of welding gases in a vertical position on the post 12, with their lower ends resting on the pallet platform 11. Hooks 14 are also provided on the post 12, such that the user may hang coiled hoses on them.

The second exemplary embodiment is similar in structure and function to the first exemplary embodiment, with the following modifications. An open-topped toolbox 15 is provided, which occupies the entire top surface of the pallet platform 11. Caster wheels 16 are provided on the corners of the bottom surface of the pallet, such that the pallet 10 and its load may be rolled across a solid surface, such as concrete.

To use the first or the second exemplary embodiment, the user lifts two tanks 21 of welding gases or other flammable gases into the pallet 10 and secures the tanks 21 to the post 12 in a vertical position, with the lower ends 22 of the tanks 21 resting on the pallet platform 11, using the ring clamps 13 which are provided. The user may then hang coiled hoses on the hooks 14 and store welding torches and other tools in the toolbox 15. The user may hang the loaded pallet from the bucket of an endloader, a crane, or other heavy equipment, using the ring 12A which is provided, and use the heavy equipment to carry the loaded pallet 10. Alternately, the loaded pallet may be carried with a forklift, using the apertures 11A which are provided.

The pallet platform 11, the post 12, the ring 12A, the crossbar 12B, the hooks 14, and the toolbox 15 are preferably manufactured from a rigid, durable material with substantial structural strength, such as aluminum alloy or steel. The ring clamps 13 are preferably manufactured from a flexible, durable material with substantial structural strength, such as spring steel. The caster wheels 16 are preferably manufactured from a rigid, durable material with substantial structural strength, such as aluminum alloy or steel, with solid or inflated tires which are preferably manufactured from a flexible, durable material, such as silicone or rubber.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A pallet for the transportation of flammable gases, comprising:
a. a pallet platform;
b. a vertical post which extends upward from the center of the pallet platform;
c. two apertures which are located on a front surface of the pallet platform and extend through to the rear surface of the pallet platform, and are configured in such a manner as to enable the pallet to be carried by a forklift;
d. a crossbar which is provided at the upper end of the post and extends side to side;
e. a ring which is provided at the center of the crossbar, configured in such a manner as to enable the pallet to be lifted upward and carried by an crane, endloader, or other heavy equipment;
f. at least one hook, which is provided on said vertical post and configured in such a manner as to enable the hanging of coiled hoses or other tools; and
g. a plurality of ring clamps attached to said vertical post and configured in such a manner as to enable the securing of at least one tank of oxygen, acetylene, or other flammable gas to said vertical post, with the lower end of the tank resting on the pallet platform.

2. The pallet of claim 1, wherein the pallet is manufactured from steel, aluminum alloy, or some other material providing substantial structural strength.

3. The pallet of claim 1, further comprising an open-topped toolbox occupying the entire top surface of the pallet platform.

4. The pallet of claim 2, further comprising an open-topped toolbox occupying the entire top surface of the pallet platform.

5. The pallet of claim 1, further comprising a plurality of caster wheels.

6. The pallet of claim 5, wherein said plurality of caster wheels equals four in number; said four caster wheels are provided on the pallet platform and configured such that the pallet and its load may be rolled.

7. The pallet of claim 5, wherein said plurality of caster wheels are retractable, such that said plurality of caster wheels are folded upward into said pallet platform.

8. The pallet of claim 6, wherein said plurality of caster wheels are retractable, such that said plurality of caster wheels are folded upward into said pallet platform.

9. The pallet of claim 2, further comprising a plurality of caster wheels.

10. The pallet of claim 9, wherein said plurality of caster wheels are retractable, such that said plurality of caster wheels are folded upward into said pallet platform.

11. The pallet of claim 3, further comprising a plurality of caster wheels.

12. The pallet of claim 11, wherein said plurality of caster wheels are retractable, such that said plurality of caster wheels are folded upward into said pallet platform.

13. The pallet of claim 4, further comprising a plurality of caster wheels.

14. The pallet of claim 13, wherein said plurality of caster wheels are retractable, such that said plurality of caster wheels are folded upward into said pallet platform.

15. The pallet of claim 1, wherein said hook is equal to two in number; said two hooks being attached opposite each other on said vertical post.

16. The pallet of claim 15, further comprising an open-topped toolbox occupying the entire top surface of the pallet platform.

17. The pallet of claim 15, further comprising a plurality of caster wheels.

18. The pallet of claim 17, wherein said plurality of caster wheels are retractable, such that said plurality of caster wheels are folded upward into said pallet platform.

19. The pallet of claim 16, further comprising a plurality of caster wheels.

20. The pallet of claim 19, wherein said plurality of caster wheels are retractable, such that said plurality of caster wheels are folded upward into said pallet platform.
